(19) United States
(12) Patent Application Publication
(10) Pub. No.: US 2020/0027111 A1
(43) Pub. Date: Jan. 23, 2020

(54) VEHICLE PROMOTION AGGREGATOR SYSTEMS

(71) Applicant: Capital One Services, LLC, McLean, VA (US)

(72) Inventors: Satish Chikkaveerappa, McKinney, TX (US); Mithra Kosur Venuraju, Frisco, TX (US); Amit Ramesh Deshpande, McKinney, TX (US)

(21) Appl. No.: 16/039,671

(22) Filed: Jul. 19, 2018

(51) Int. Cl. G06Q 30/02; G06Q 10/08

(52) U.S. Cl. CPC G06Q 30/0223; G06Q 30/0211; G06Q 10/087

(57) ABSTRACT

Vehicle promotion aggregator systems for providing customized promotion (dealership and/or service provider) recommendations is disclosed. The system may include processor(s) and memory storing instructions that, when executed by the processor(s), are configured to performs steps of a method. Responsive to receiving a promotion identification request for a customer and one or more promotions associated with the vehicle from both a service provider and dealership system, the system may determine an aggregated promotion recommendation for one or more selected vehicle(s) on an inventory website. The system may provide, via the API, the determined aggregated promotion recommendation for display on the inventory website. The aggregated promotion recommendation may also include geographical and/or time-window based recommendations for purchasing the vehicle. The system may also provide recommended new promotions based on tracked historical promotion data to one or more of the dealership and service provider systems.

### FIELD OF THE INVENTION

The presently disclosed subject matter relates generally to vehicle promotion aggregator systems, and more particularly to providing customized combination(s) of vehicle acquisition (e.g., purchase or lease) promotions based on a buyer's financial profile and promotional preferences.

### BACKGROUND

Traditionally, purchasing or leasing a car from a dealer is an arduous process. A prospective customer must shop for a new vehicle often with limited details on what loan terms the customer will ultimately qualify for. After a vehicle of interest is identified, the customer may visit a lender-sponsored online loan application to get an idea if the identified vehicle is one that he or she can reasonably afford. These online loan applications often require the customer to leave a website listing vehicles for sale to visit a third-party lender's website to apply for a vehicle-specific loan, requiring additional time and effort from the customer. Additionally, when the customer visits the third-party website, he or she is often only presented with dealership-specific promotion(s) offered by the dealership selling the identified vehicle. Identifying competing dealership promotions or even service provider promotions, which may impact a post-purchase warranty, for similar vehicles requires even more time and effort on behalf of the customer.

Accordingly, there is a need for improved vehicle acquisition (e.g., purchase or lease) promotion information systems to provide prospective customers with available promotions and customer-specific financing terms in view of those promotions. Embodiments of the present disclosure are directed to this and other considerations

### SUMMARY

Consistent with a disclosed embodiment, a system and method for providing a vehicle promotion aggregator is disclosed. The system may comprise one or more processors and a memory in communication with the processor(s) and storing instructions that, when executed by the processor(s), are configured to cause the system to perform operations consistent with disclosed embodiments. For example, in some embodiments, the system may receive, from a dealership server via a real-time application programming interface (“API”) configured to provide promotion recommendations a promotion identification request for a customer. The promotion identification request for a customer may include customer identification information, customer preferences information, and information associated with at least one vehicle contained within an inventory listing presented on a dealership website associated with the dealership system. The system may receive one or more service provider promotions associated with the vehicle contained in the inventory listing from a service provider system and, similarly, one or more dealership promotions associated with the vehicle contained in the inventory listing from a dealership system. Based at least in part on the customer preferences, the system may determine an aggregated promotion recommendation including at least a first service provider promotion of the service provider promotions and a first dealership promotion of the dealership promotions for the vehicle. The determined aggregated promotion recommendation may include prospective financial discount information corresponding to each of the selected vehicles. Once determined, the system may provide the aggregated promotion recommendation to the dealership via the real-time API for presentation on the dealership website.

Consistent with the disclosed embodiments, methods for providing personalized aggregated vehicle promotion recommendations are also disclosed.

Further features of the disclosed design, and the advantages offered thereby, are explained in greater detail hereinafter with reference to specific embodiments illustrated in the accompanying drawings, wherein like elements are indicated be like reference designators.

### BRIEF DESCRIPTION OF THE DRAWINGS

The accompanying drawings, which are incorporated and constitute a part of this specification, illustrate various embodiments and aspects of the disclosed embodiments and, together with the description, serve to explain the principles of the disclosed embodiments. In the drawings:

FIG. 1 illustrates an exemplary vehicle promotion aggregator system consistent with disclosed embodiments;

FIG. 2 is a component diagram of an exemplary promotional aggregator system for use in the vehicle promotion aggregator system of FIG. 1;

FIG. 3 is a flowchart of an exemplary method of using a promotional aggregator system, according to an example embodiment;

FIG. 4 is a flowchart of an exemplary method of determining a suggested time window or geographic location to purchase a vehicle, according to an example embodiment; and

FIG. 5 is a flowchart of an exemplary method of providing a suggested new promotion to the dealership and/or service provider systems, according to an example embodiment.

### DETAILED DESCRIPTION

Some implementations of the disclosed technology will be described more fully with reference to the accompanying drawings. This disclosed technology may, however, be embodied in many different forms and should not be construed as limited to the implementations set forth herein. The components described hereinafter as making up various elements of the disclosed technology are intended to be illustrative and not restrictive. Many suitable components that would perform the same or similar functions as components described herein are intended to be embraced within the scope of the disclosed electronic devices and methods. Such other components not described herein may include, but are not limited to, for example, components developed after development of the disclosed technology.

It is also to be understood that the mention of one or more method steps does not preclude the presence of additional method steps or intervening method steps between those steps expressly identified. Similarly, it is also to be understood that the mention of one or more components in a device or system does not preclude the presence of additional components or intervening components between those components expressly identified.

Generally, the disclosed embodiments are directed to systems and methods for providing a vehicle promotion aggregator and, more specifically, providing a real-time application programming interface (“API”) that may be used in conjunction with a web service to provide prospective customers with the ability to shop on a website listing items for sale with enhanced information about a prospective buyer's approval status, loan terms, and a preselected combination of preferred promotions.

In one aspect, a system for providing personalized aggregated promotion recommendations for incorporation into a dealership website is disclosed. Specifically, the system may include one or more memory devices storing instructions, and one or more processors configured to execute the instructions to perform the steps of a method. The system may receive, from a dealership server, via a real-time API configured to provide promotion recommendations a promotion identification request for a customer. The promotion identification request for a customer may include customer identification information (e.g. Customer name, Social Security Number, etc.), customer preferences information, and information associated with at least one vehicle contained within an inventory listing presented on a dealership website associated with the dealership system. The system may receive, from a service provider system, one or more service provider promotions associated with the at least one vehicle contained in the inventory listing. The system may also receive, from a dealership system, one or more dealership promotions associated with the at least one vehicle contained in the inventory listing. In response to the received promotions, the system may determine an aggregated promotion recommendation. The aggregated promotion recommendation may include a first service provider promotion of the one or more service provider promotions and a first dealership promotion of the one or more dealership promotions for the at least one vehicle based. The aggregated promotion recommendation may be determined based on the customer preferences information. The system may provide to the dealership server via the real-time API the determined aggregated promotion recommendation for presentation on the dealership website. In some embodiments, the determined aggregated promotion recommendation may include prospective financial discount information corresponding to each of the selected vehicles.

In some embodiments, the determined aggregated promotion recommendation may further include, for each of the at least one vehicle, a total price of the at least one vehicle, a risk value indicating potential future costs not covered by the service provider promotions and the dealership promotion, and a total savings value that the service provider promotion and the dealership promotion provide.

In another embodiment, the system is further configured to receive, from the dealership system via the real-time API, a customer-input indication of acceptance of the determined aggregated promotion recommendation. In response to the acceptance, the system may provide, to the dealership system and the service provider system via the real-time API, a promotion lock message. The promotion lock message may indicate the acceptance of the determined aggregated promotion recommendation.

In another embodiment, each of the at least one vehicle has an associated vehicle type. Determining an aggregated promotion recommendation may further include tracking historical promotion data of at least the first service provider promotion and the first dealership promotion for the associated vehicle type. The system may further include determining a suggested time window to purchase of the at least one vehicle based on the historical promotion data. Alternatively, in other embodiments, the system may further include determining a suggested geographic location to purchase each of the at least one vehicle based on the historical promotion data.

In another embodiment, each of the at least one vehicle has an associated vehicle type. Determining an aggregated promotion recommendation may further include tracking historical promotion data for the associated vehicle type of the at least one vehicle. The historical promotion data may include the first dealership promotion, inventory data for the associated vehicle type for each of the at least one vehicle, and a customer acceptance rate of the first dealership promotion. The system may be configured to provide, to the dealership system, a suggested new promotion based on the tracked historical promotion data.

In another embodiment, each of the at least one vehicle has an associated vehicle type. Determining an aggregated promotion recommendation may further include tracking historical promotion data for the associated vehicle type of the at least one vehicle. The historical promotion data may include the first service provider promotion, inventory data for the associated vehicle type for each of the at least one vehicle, and a customer acceptance rate of the first service provider promotion. The system may be configured to provide, to the service provider system, a suggested new promotion based on the tracked historical promotion data.

In another embodiment, the promotion identification request may further include customer financial information. The system may be further configured to determine personalized financing information for the at least one vehicle based on the customer financial information and the determined aggregated promotion recommendations. The system may provide, to the dealership system, via the real-time API, the personalized financing information for presentation on the dealership website.

In another aspect, a promotion aggregator system for providing personalized aggregated promotion recommendations for incorporation into an inventory website via an API is disclosed. Specifically, the system may include one or more memory devices storing instructions, and one or more processors configured to execute the instructions to perform the steps of a method. The system may receive, from an inventory server via a real-time API a promotion identification request for a customer. In some embodiments, the API is configured to provide promotion recommendations. The promotion identification request for a customer may include customer identification information, customer preferences information, and information associated with at least one item contained within an inventory listing presented on an inventory website associated with the inventory system. The system may receive, from a service provider system, one or more service provider promotions associated with the at least one item contained in the inventory listing. The system may further receive, from a dealership system, one or more dealership promotions associated with the at least one item contained in the inventory listing. Similarly, the system may receive, from a dealership system, one or more dealership promotions associated with the at least one item contained in the inventory listing. In response to the received promotions, the system may determine an aggregated promotion recommendation. The aggregated promotion recommendation may include a first service provider recommendation of the one or more service provider promotions, and a first dealership promotion of the one or more dealership promotions for the at least one item in the inventory listing. Further, in some embodiments, the aggregated promotion recommendation may be based on the customer preferences information. The system may provide, to the inventory server, via the real-time API, the determined aggregated promotion recommendation. The aggregated promotion recommendation may be presented on the inventory website and may include prospective financial discount information corresponding to the at least one item in the inventory listing.

In some embodiments, the determined aggregated promotion recommendation may further include, for reach of the at least one vehicle, a total price of the vehicle, a risk value indicative of potential future costs not covered by the service provider promotions and the dealership promotion, and a total savings value that the service provider promotion and the dealership promotion provide.

In another embodiment, the system may be further configured to receive, from the inventory system via the real-time API, a customer-input indication of acceptance of the determined aggregated promotion recommendation. In response to the acceptance, the system may provide, to the dealership system and the service provider system, via the real-time API, a promotion lock message. The promotion lock message may indicate the acceptance of the determined aggregated promotion recommendation.

In another embodiment, the system may further include determining an associated vehicle type for each of the at least one vehicle. Determining an aggregated promotion recommendation may further include tracking historical promotion data of at least the first service provider promotion and the first dealership promotion for the associated vehicle type of the at least one vehicle. The system may further determine a suggested time window to purchase each of the at least one vehicle based on the historical promotion data. In another embodiment, the system may further determine a suggested geographic location to purchase each of the at least one vehicle based on the historical promotion data.

In another embodiment, each of the at least one vehicle has an associated vehicle type. Determining an aggregated promotion recommendation may further comprise tracking historical promotion data for the associated vehicle type of the at least one vehicle. The historical promotion data may include the first dealership promotion, inventory data for the associated vehicle type for each of the at least one vehicle, and a customer acceptance rate of the first dealership promotion. The system may be further configured to provide, to the dealership system, a suggested new promotion based on the tracked historical promotion data. In another embodiment, the system may be further configured to provide, to the service provider system, a suggested new promotion based on the tracked historical promotion data.

In another embodiment, the promotion identification request may further include customer financial information. The system may be further configured to determine personalized financing information for the at least one vehicle based on the customer financial information and the determined aggregated promotion recommendation. The system may further provide, to the inventory host system, via the real-time API, the personalized financing information for presentation on the inventory host website.

In yet another aspect, a method for providing personalized aggregated vehicle promotion recommendations is disclosed. The method may include receiving a promotion identification request for a customer. The promotion identification request may include customer identification information, customer preferences information, and information associated with at least one item contained within an inventory listing presented on an inventory website. The method may include receiving, from a service provider system, one or more service provider promotions associated with the at least one item contained in the inventory listing. The method may further include receiving, from a dealership system, one or more dealership promotions associated with the at least one item contained in the inventory listing. The system may further determine an aggregated promotion recommendation including at least one service provider promotion and at least one dealership promotion for the at least one item based on the customer preferences information. Additionally, the system may provide the determined aggregated promotion recommendation for display on the inventory website. The determined aggregated promotion recommendation may include prospective financial discount information corresponding to each of the items contained in the inventory listing.

In some embodiments, the promotion identification request may further include customer financial information. The method may further include determining personalized financing information for the at least one vehicle based on the customer financial information and the determined aggregated promotion recommendation. The method may further include the step of providing the personalized financing information for display on the inventory website.

In some embodiments, each of the at least one vehicle has an associated vehicle type. Determining an aggregated promotion recommendation may further include the steps of tracking historical promotion data of at least the first service provider promotion and the first dealership promotion for the associated vehicle type of the at least one vehicle. In some embodiments, the method may further include determining a suggested time window to purchase each of the at least one vehicle based on the historical promotion data. In other embodiments, the method may further include determining a suggested geographic location to purchase each of the at least one vehicle based on the historical promotion data.

Reference will now be made in detail to exemplary embodiments of the disclosed technology, examples of which are illustrated in the accompanying drawings and disclosed herein. Wherever convenient, the same references numbers will be used throughout the drawings to refer to the same or like parts.

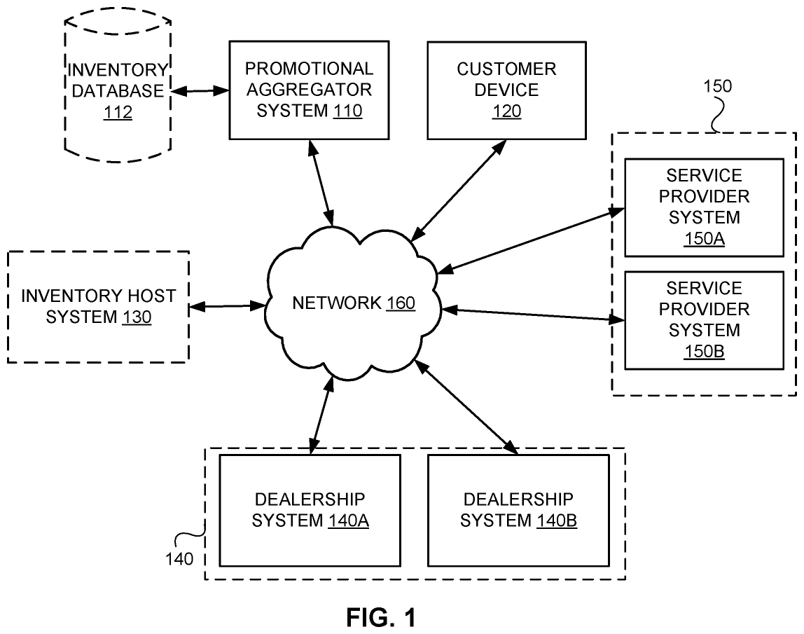

FIG. 1 illustrates an exemplary system 100 consistent with the disclosed embodiments. In one aspect, as shown, system 100 may include a promotional aggregator system 110, an inventory database 112, a customer device 120, an inventory host system 130, a dealership system 140, a service provider system 150, and a network 160. In some embodiments, the promotional aggregator system 110, which may operate in conjunction with an external inventory host system 130 or may host its own inventory listing (e.g., using the inventory database 112), may provide customized, aggregated promotion combination(s) to the customer device 120 via the network 160 and based on customer preferences and promotional information from the dealership system 140 and/or the service provider system 150. In other embodiments, the promotional aggregator system 110 may track customer preferences and their acceptance of various promotions and promotion combinations over time and, in turn, provide recommended promotions to one or more of the dealership system 140 and the service provider system 150 via the network.

The promotional aggregator system 110 may be configured to receive and aggregate promotional offers from a plurality of sources including one or more of the dealership system 140 and the service provider system 150. The promotional offers may correspond to at least one of a selection of vehicles contained in an inventory listing. In one aspect, the promotional aggregator system 110 may make a recommendation of a preferred combination of promotions, with at least one promotion included from the dealership system 140 and at least one promotion included from the service provider system 150. In some embodiments, the promotional aggregator system 110 may provide an aggregated promotion recommendation including prospective financial discount information corresponding to each selected vehicle of the vehicle inventory. In other embodiments, the promotional aggregator system 110 may receive from the dealership system 140 customer financial information. The promotional aggregator system 110 may determine personalized financing information for the at least one vehicle based on the customer financial information and the determined aggregated promotion recommendation. Further, the promotional aggregator system 110 may provide, to the dealership system via the real-time API, the personalized financing information for presentation on the dealer website. Accordingly, the promotional aggregator system 110 may provide inventory items meeting the customer financial information and display personalized financing information including details such as loan term, loan interest rate, and the monthly payment. The promotional aggregator system 110 may include one or more components that perform processes consistent with the disclosed embodiments. For example, the promotional aggregator system 110 may include one or more computers (e.g., servers, database systems, etc.) configured to execute software instructions programmed to perform aspects of the disclosed embodiments, such as processing information relating to the promotion identification request that may be received from the dealership system 140. The promotional aggregator system 110 may also be configured to execute stored software instructions to implement the API for providing prospective customers requiring financing the ability to shop for the item on a web site, such as one provided by the dealership system 140 or the inventory host system 130, and the website may be configured to list items for sale with personalized financing information, such as personalized loan terms specific to a vehicle selected in the inventory, and a listing of the one or more inventory items that meet the approved loan terms, etc. Consistent with the disclosed embodiments, the promotional aggregator system 10 may be configured to provide, manage, monitor, and assess a prospective recommended combination of promotions from one or more of the dealership system 140, the inventory host system 130, and the service provider system 150.

The inventory database 112 may be associated with the promotional aggregator system 110, and in some embodiments, the inventory database 112 may store inventory listings of all the vehicles available for purchase or lease on the system 100.

The customer device 120 may represent a system associated with an entity seeking to buy an item from another party. The customer device 120 may be configured to transmit and receive information associated with accessing a website, such as a website operated by the dealership system 140 offering promotional offers for items listed on the website through an API associated with the promotional aggregator system 110. The customer device 120 may include one or more components that perform processes consistent with the disclosed embodiments. For example, the customer device 120 may include one or more computers (e.g., servers, database systems, etc.) that are configured to execute software instructions programmed to perform aspects of the disclosed embodiments.

The inventory host system 130 may include one or more systems configured to receive, process, display, and transmit information associated with items for sale (e.g., automotive vehicles). In some embodiments, multiple dealership systems 140 (e.g., dealership systems 140A, 140B, etc.) may be configured to access a common inventory listing hosted by the inventory host system 130. The inventory host system 130 may be associated with the seller of the vehicles (e.g., a typical dealership) or with a third-party to the sale (e.g., cars.com™). The inventory host system 130 may include components that enable it to perform processes consistent with the disclosed embodiments. For example, the inventory host system 130 may provide web sites that offer vehicle listings and communicate with the promotional aggregator system 110 or other components through an API to provide a suggested combination of promotions associated with those vehicle listings.

The dealership system 140 may include multiple separate dealership systems 140A, 140B, etc. (known collectively as the dealership system 140). The dealership system 140 may be configured to receive, process, display, and transmit information associated with items for sale (e.g., automotive vehicles). The dealership system 140 may be associated with the seller of the vehicles. The dealership system 140 may include components that enable it to perform processes consistent with the disclosed embodiments. For example, the dealership system 140 may provide websites that offer vehicle listings and communicate with the promotional aggregator system 110 or other components through an API to provide a suggested combination of promotions associated with those vehicle listings.

The service provider system 150 may include multiple separate service provider systems 150A, 150B, etc. (known collectively as the service provider system 150). The service provider system 150 may be configured to receive, process, display, and transmit information associated with items for sale (e.g., automotive vehicles). The service provider system 150 may be associated with a third-party to the sale of the vehicles (e.g. cars.com). The service provider system 150 may include components that enable it to perform processes consistent with the disclosed embodiments. For example, the service provider system 150 may provide websites that offer vehicle listings and communicate with the promotional aggregator system 110 or other components through an API to provide a suggested combination of promotions associated with those vehicle listings.

Facilitating communication between components of the system 100, the network 160 may be of any suitable type, including individual connections via the Internet such as cellular or WiFi networks. In some embodiments, the network 160 may connect terminals, services, and mobile devices using direct connections such as radio-frequency identification (RFID), near-field communication (NFC), Bluetooth™, low-energy Bluetooth™ (BLE), WiFi™, Ethernet, ZigBee™, ambient backscatter communications (ABC) protocols, USB, WAN, or LAN. Because the information transmitted may be personal or confidential, security concerns may dictate one or more of these types of connections be encrypted or otherwise secured. In some embodiments, however, the information being transmitted may be less personal, and therefore the network connections may be selected for convenience over security.

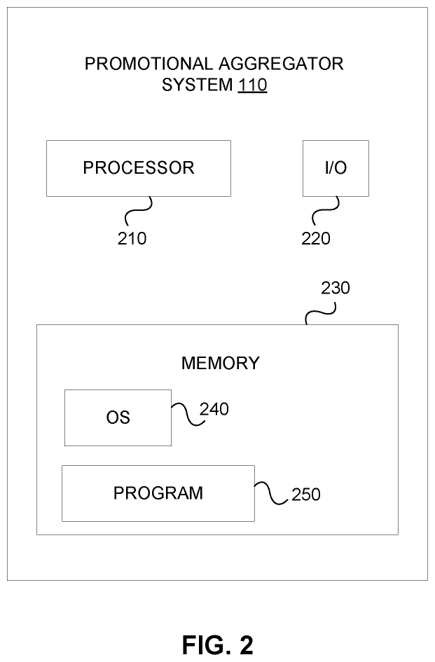

Components of the promotional aggregator system 110 are shown in more detail in FIG. 2. The customer device 120, the inventory host system 130, the dealership system 140, and the service provider system 150 all may have a similar structure and components that are similar to those described with respect to the promotional aggregator system 110. As shown, the promotional aggregator system 110 may include a processor 210, an input/output (“I/O”) device 220, a memory 230 containing an operating system (“OS”) 240 and a program 250. For example, the promotional aggregator system 110 may be a single server or may be configured as a distributed computer system including multiple servers or computers that interoperate to perform one or more of the processes and functionalities associated with the disclosed embodiments. In some embodiments, the promotional aggregator system 110 may further include a display (or a display interface), a peripheral interface, a transceiver, a mobile network interface in communication with the processor 210, a bus configured to facilitate communication between the various components of the promotional aggregator system 110, and a power source configured to power one or more components of the promotional aggregator system 110. A display may include any conventional display mechanism such as a flat panel display, projector, or any other display mechanism known to those having ordinary skill in the art. In some embodiments, a display, in conjunction with suitable stored instructions, may be used to implement a graphical user interface. In other embodiments, a display may include a display interface configured to receive or communicate with one or more external displays. The promotional aggregator system 110 may further include a sound interface, a camera interface, a telephony subsystem, an antenna interface, and a GPS receiver.

A peripheral interface may include the hardware, firmware and/or software that enables communication with various peripheral devices, such as media drives (e.g., magnetic disk, solid state, or optical disk drives), other processing devices, or any other input source used in connection with the instant techniques. In some embodiments, a peripheral interface may include a serial port, a parallel port, a general purpose input and output (GPIO) port, a game port, a universal serial bus (USB), a micro-USB port, a high definition multimedia (HDMI) port, a video port, an audio port, a Bluetooth port, a near-field communication (NFC) port, another like communication interface, or any combination thereof.

In some embodiments, a transceiver may be configured to communicate with compatible devices and ID tags when they are within a predetermined range. A transceiver may be, for example, compatible with one or more of: radio-frequency identification (RFID), near-field communication (NFC), Bluetooth®, low-energy Bluetooth® (BLE), WiFi™, ZigBee®, ambient backscatter communications (ABC) protocols or similar technologies.

A mobile network interface may provide access to a cellular network, the Internet, or another wide-area network. In some embodiments, a mobile network interface may include hardware, firmware, and/or software that allows the processor(s) 210 to communicate with other devices via wired or wireless networks, whether local or wide area, private or public, as known in the art. A power source may be configured to provide an appropriate alternating current (AC) or direct current (DC) to power components.

The processor 210 may include one or more of a microprocessor, microcontroller, digital signal processor, co-processor or the like or combinations thereof capable of executing stored instructions and operating upon stored data. Memory 230 may include, in some implementations, one or more suitable types of memory (e.g. such as volatile or non-volatile memory, random access memory (RAM), read only memory (ROM), programmable read-only memory (PROM), erasable programmable read-only memory (EPROM), electrically erasable programmable read-only memory (EEPROM), magnetic disks, optical disks, floppy disks, hard disks, removable cartridges, flash memory, a redundant array of independent disks (RAID), and the like), for storing files including an operating system, application programs (including, for example, a web browser application, a widget or gadget engine, and or other applications, as necessary), executable instructions and data. In one embodiment, the processing techniques described herein are implemented as a combination of executable instructions and data within the memory 230.

The processor 210 may be one or more known processing devices, such as a microprocessor from the Pentium™ family manufactured by Intel™ or the Ryzen™ family manufactured by AMD™. The processor 210 may constitute a single core or multiple core processor that executes parallel processes simultaneously. For example, the processor 210 may be a single core processor that is configured with virtual processing technologies. In certain embodiments, the processor 210 may use logical processors to simultaneously execute and control multiple processes. The processor 210 may implement virtual machine technologies, or other similar known technologies to provide the ability to execute, control, run, manipulate, store, etc. multiple software processes, applications, programs, etc. In another embodiment, the processor 210 may include a multiple-core processor arrangement (e.g., dual or quad core) that is configured to provide parallel processing functionalities to allow the promotional aggregator system 110 to execute multiple processes simultaneously. One of ordinary skill in the art would understand that other types of processor arrangements could be implemented that provide for the capabilities disclosed herein.

The promotional aggregator system 110 may include one or more storage devices configured to store information used by processor 210 (or other components) to perform certain functions related to the disclosed embodiments. In one example, the promotional aggregator system 110 may include memory 230 that includes instructions to enable processor 210 to execute one or more applications, such as server applications, network communication processes, and any other type of application or software known to be available on computer systems. Alternatively, the instructions, application programs, etc. may be stored in an external storage or available from a memory over a network. The one or more storage devices may be a volatile or non-volatile, magnetic, semiconductor, tape, optical, removable, non-removable, or other type of storage device or tangible computer-readable medium.

In one embodiment, the promotional aggregator system 110 includes memory 230 that includes instructions that, when executed by processor 210, perform one or more processes consistent with the functionalities disclosed herein. Methods, systems, and articles of manufacture consistent with disclosed embodiments are not limited to separate programs or computers configured to perform dedicated tasks. For example, the promotional aggregator system 110 may include memory 230 that may include one or more programs 250 to perform one or more functions of the disclosed embodiments. Moreover, processor 210 may execute one or more programs 250 located remotely from the vehicle promotion aggregator system 100. For example, the system 100 may access one or more remote programs 250, that, when executed, perform functions related to disclosed embodiments.

Memory 230 may include one or more memory devices that store data and instructions used to perform one or more features of the disclosed embodiments. Memory 230 may also include any combination of one or more databases controlled by memory controller devices (e.g., server(s), etc.) or software, such as document management systems, Microsoft SQL databases, SharePoint databases, Oracle™ databases, Sybase™ databases, or other relational databases. Memory 230 may include software components that, when executed by processor 210, perform one or more processes consistent with the disclosed embodiments.

The promotional aggregator system 110 may also be communicatively connected to one or more memory devices (e.g., databases (not shown)) locally or through a network (e.g., network 160). The remote memory devices may be configured to store information and may be accessed and/or managed by the promotional aggregator system 110. By way of example, the remote memory devices may be document management systems, Microsoft SQL database, SharePoint databases, Oracle™ databases, Sybase™ databases, or other relational databases. Systems and methods consistent with disclosed embodiments, however, are not limited to separate databases or even to the use of a database.

The promotional aggregator system 110 may also include one or more I/O devices 220 that may comprise one or more interfaces for receiving signals or input from devices and providing signals or output to one or more devices that allow data to be received and/or transmitted by the promotional aggregator system 110. For example, the promotional aggregator system 110 may include interface components, which may provide interfaces to one or more input devices, such as one or more keyboards, mouse devices, touch screens, track pads, trackballs, scroll wheels, digital cameras, microphones, sensors, and the like, that enable the promotional aggregator system 110 to receive data from one or more users. In other exemplary embodiments, the I/O devices 220 may serve as the sound interface and/or the camera interface to present information to a user and capture information from a device's environment including instructions from the device's user. As additional examples, input components may include an accelerometer (e.g., for movement detection), a magnetometer, a digital camera, a microphone (e.g., for sound detection), an infrared sensor, an optical sensor, and a GPS receiver.

In exemplary embodiments of the disclosed technology, the promotional aggregator system 110 may include any number of hardware and/or software applications that are executed to facilitate any of the operations. In example implementations, one or more I/O interfaces facilitate communication between the promotional aggregator system 110 and one or more input/output devices. For example, a universal serial bus port, a serial port, a disk drive, a CD-ROM drive, and/or one or more user interface devices, such as a display, keyboard, keypad, mouse, control panel, touch screen display, microphone, etc., may facilitate user interaction with the computing device. The one or more I/O interfaces may be utilized to receive or collect data and/or user instructions from a wide variety of input devices. Received data may be processed by one or more computer processors as desired in various implementations of the disclosed technology and/or stored in one or more memory devices.

While the promotional aggregator system 110 has been described as one form for implementing the techniques described herein, those having ordinary skill in the art will appreciate that other, functionally equivalent techniques may be employed. For example, as known in the art, some or all of the functionality implemented via executable instructions may also be implemented using firmware and/or hardware devices such as application specific integrated circuits (ASICs), programmable logic arrays, state machines, etc. Furthermore, other implementations of the promotional aggregator system 110 may include a greater or lesser number of components than those illustrated.

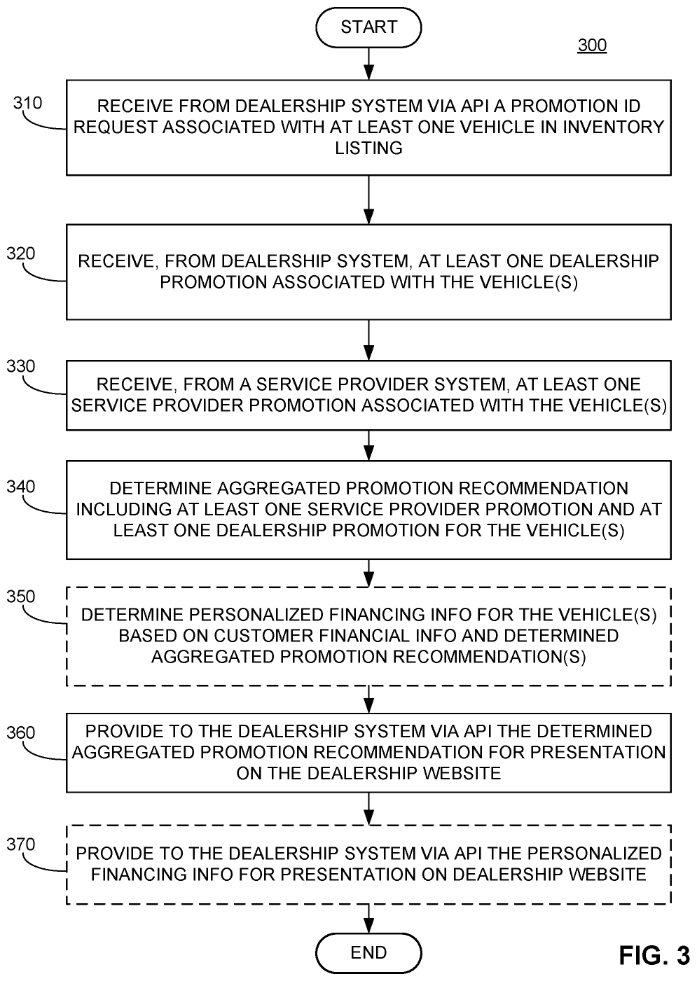

FIG. 3 shows a flowchart of an exemplary method of using a promotional aggregator system 110, according to an example embodiment. In block 310, the system (e.g., promotional aggregator system 110) may receive, from a dealership system via a real-time API, a promotion identification request. The promotional identification request may be associated with at least one vehicle in an inventory listing. The inventory listing may be hosted by one of the promotional aggregator system 110, the inventory host system 130, or the dealership system 140. When the website is hosted by the promotional aggregator system 110, the inventory listing data may be stored on the inventory database 112, which may be directly connected to the promotional aggregator system 110. The promotional identification request of block 310 may include customer identification information, customer preferences information, and information associated with at least one vehicle contained within an inventory listing. Customer identification information may include a customer's name, date of birth, email address, mailing address, a username and/or passcode authenticating the customer as the person he or she purports to be, etc. In some embodiments, the customer preferences information may include prioritizing the interest rate, total monthly payment, number of payments, down payment, or other loan factors over the remaining loan factors. Customer preferences may further include prioritizing certain service promotions over others (e.g., a customer may prioritize free lifetime oil changes more than a yearly free alignment package). Vehicle inventory information may include information indicating whether a vehicle make, year, model, or vehicle identification number (“VIN”) has a promotion associated with a vehicle.

In block 320, the system (e.g., promotional aggregator system 110) may receive, from the dealership system 140, at least one dealership promotion associated with the at least one vehicle selected in the inventory listing. The dealership promotion associated with the at least one vehicle may be aggregated with one or more service provider promotions. The dealership promotion may include total price discounts, special loan interest rate offers, total monthly payment discounts, down payment waivers, and the like.

In block 330, the system (e.g., promotional aggregator system 110) may receive, from the service provider system 150, at least one service provider promotion associated with the at least one vehicle. The service provider promotions may include service discounts (e.g., free oil changes for a vehicle bought from a participating dealer, free wheel alignment for one year after vehicle purchase, etc.). The service provider promotions may also include complementary product offers available for the at least one vehicle (e.g., free oil filter when you buy a vehicle from a participating dealer, etc.).

In block 340 the system (e.g., promotional aggregator system 110) may determine an aggregated promotion recommendation based on the received at least one service provider promotion 330 and the received at least one dealership promotion 320. The aggregated promotion recommendation may include at least one service provider promotion and at least one dealership promotion for the selected vehicle(s). In some embodiments, the determined 340 aggregated promotion recommendation may further include, for each of the vehicle(s), a total price for the vehicle(s), a risk value indicative of potential future costs not covered by the service provider promotion(s) and the dealership promotion(s), and a total savings value that the service provider and dealership promotions(s) provide. Accordingly, the promotional aggregator system 110 may preselect a preferred combination of promotions from the dealership system and service provider system based on customer preferences for prioritizing certain financial criteria such as the interest rate, total monthly payment, total number of payments, down payment, or other loan factors over the remaining loan factors.

In some embodiments, the promotional aggregator system 110 may receive customer financial information. The customer financial information may include a customer's credit history, loan history, employment information, and the like. In some embodiments, the system may be further configured to determine 350 personalized financing information for the at least one vehicle based on the received customer financial information and the determined 340 aggregated promotion recommendations. The personalized financing information may include specific loan terms that the customer has been approved for as they apply to selected vehicles of the inventory system. The system may be further configured to provide, to the dealership system 140 via the real-time API, the personalized financing information for presentation on the dealership website.

In block 360, the system (e.g., the promotional aggregator system 110) may provide to the dealership system 140 via the real-time API, the determined aggregated promotion recommendation for presentation on the dealership website. Accordingly, a customer may be able to view a preselected combination of promotions from the dealership system and the service provider system as applied to the vehicles selected from the vehicle inventory.

In some embodiments, the system (e.g., promotional aggregator system 110) may provide 370 to the dealership system 140 via the real-time API the personalized financing information including specific loan terms for each vehicle selected from the vehicle inventory, which may be based at least in part on the customer financial information that may be provided to the system as part of the promotion identification request. The personalized financing information may include specific loan terms that the customer has been approved for as they apply to selected vehicles of the inventory system.

In some embodiments, the system (e.g., promotional aggregator system 110) may be further configured to receive, from the dealership system via the real-time API, a customer-input indication of acceptance of the determined aggregated promotion recommendation. In response to the acceptance, the system may be configured to provide, to the dealership system and/or the service provider system via the real-time API, a promotion lock message. The promotion lock message may indicate to the dealership and/or service provider system(s) that the preselected determined aggregated promotion recommendation has been accepted by the customer.

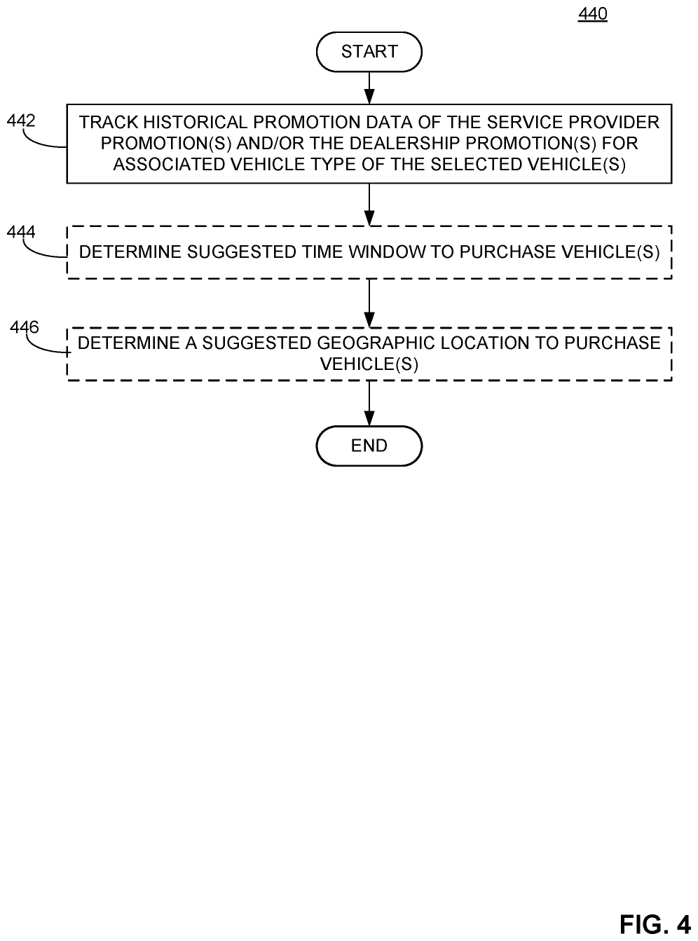

FIG. 4 shows a flowchart of an exemplary method of determining a suggested time window or geographic location to purchase a vehicle, which may be included as part of determining an aggregated promotion recommendation in block 340 according to some exemplary embodiments. In some embodiments, the system (e.g., the promotional aggregator system 110) may be further configured to determine a suggested time window to purchase a vehicle type associated with a selected vehicle from the vehicle inventory (e.g., according to historical promotion data, the vehicle type of interest may have the largest financial discount if bought in the month of November). The promotional aggregator system 110 may also determine a suggested geographic location. For example, the promotional aggregator system 110 may be configured to provide, to the dealership system 140, a recommendation suggesting a geographic area where the vehicle type of interest may have advantageous personalized financing terms due to the aggregated promotions applicable at that geographic location (e.g., Ford F-150 trucks, based on historical promotion data, sell for, on average, $6,000 less in the Southeast than in the Midwest, and therefore determining the southeast as the suggested geographic location to purchase a vehicle of that type).

In block 442, the system (e.g., the promotional aggregator system 110) may track historical promotion data of the service provider promotion(s) and/or the dealership promotion(s) for the associated vehicle type of the selected vehicle type(s). Historical promotion data may include data on what promotions were offered by the service providers and the dealerships for each vehicle type by location and by date, the total dollar value of the promotions, the monthly payment discount data due to each offered promotion, and the like. Historical promotion data may, in some embodiments, further include promotion data, inventory data for each vehicle type, and a customer acceptance rate for each promotion.

In block 444, the system (e.g., the promotional aggregator system 110) may determine a suggested time window to purchase a vehicle. For example, if the customer preferences indicate that total price is the most important consideration, the system may determine a suggested time to purchase a vehicle based on the time of year that the customer is likely to receive the greatest total price discount from the aggregated promotions according to the historical promotion data. If, for example, the customer preferences indicate that the monthly payment price is the most important financial factor, the system may provide a recommended time to purchase a vehicle when the aggregated promotions provide the lowest monthly payment but not necessarily the lowest total price for a vehicle type, when the suggested time window is compared to other possible time windows.

In block 446, the system (e.g., the promotional aggregator system 110) may determine a suggested geographic location to purchase a vehicle. For example, if the customer preferences indicate that total price is the most important consideration, the system may determine a suggested geographic location to purchase a vehicle based on the location that the customer is likely to receive the greatest total price discount from the aggregated promotions according to the historical promotion data. If, for example, the customer preferences indicate that the monthly payment price is the most important financial factor, the system may provide a recommended geographic location to purchase a vehicle when the aggregated promotions provide the lowest monthly payment, but not necessarily the lowest total price for a vehicle type, when the suggested geographic location is compared to other possible locations.

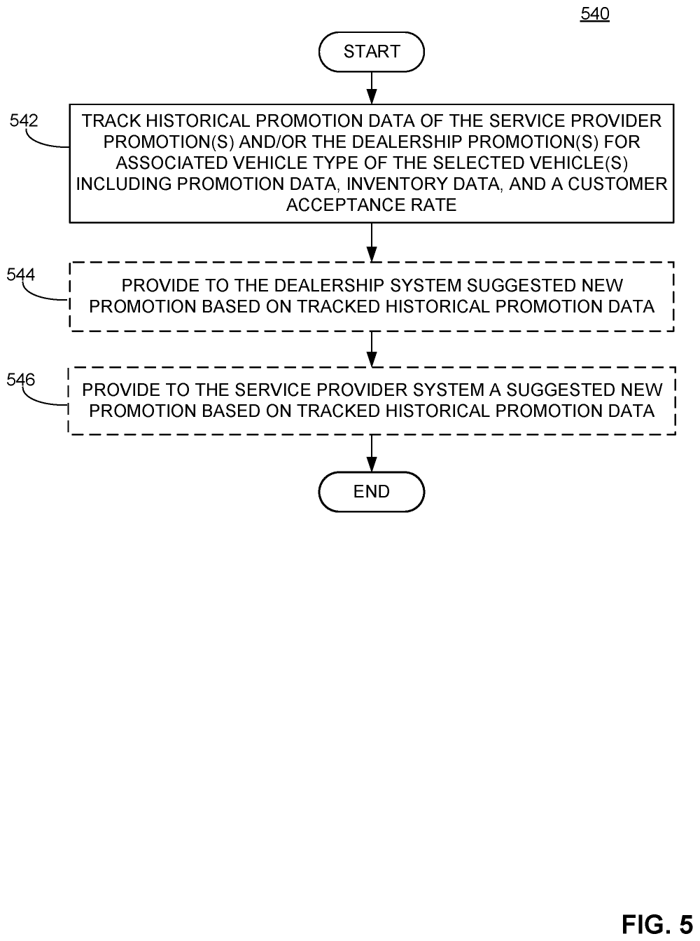

FIG. 5 shows a flowchart of an exemplary method of providing to one or more of the dealership and service provider systems a suggested new promotion, which may be included as part of determining an aggregated promotion recommendation in block 340 according to some exemplary embodiments (e.g., the recommendation may include the new promotion(s)). In block 542, the system (e.g., the promotional aggregator system 110) may, track the historical promotion data of the service provider promotion(s) and/or the dealership promotion(s) for the associated vehicle type of the selected, from the inventory, vehicle(s). The historical promotion data may include, in some embodiments, promotion data, inventory data for each vehicle type, and a customer acceptance rate for each promotion.

In block 544, the system (e.g., promotional aggregator system 110) may provide to the dealership system a suggested new promotion based on the tracked historical promotion data. Similarly, in block 546, the system (e.g., the promotional aggregator system 110) may provide to the service provider system a suggested new promotion based on tracked historical promotion data. For example, the promotional aggregator system 110 may determine that a promotion offering a 0% interest rate on the first 60 months of a vehicle loan term for a specific vehicle type led to a high customer acceptance rate for the promotion on that vehicle type. The promotional aggregator system 110 may, after determining that a particular promotion for a specific vehicle type has led to an increase in the customer acceptance rate suggest to the dealership system 140 a similar promotion on a different vehicle type. The suggested new promotion provided to the service provider system works similarly. If the promotional aggregator system 110 determines that a particular promotion has led to an increase of sales and/or profit of a particular vehicle type, the promotional aggregator system 110 may provide a recommendation to offer a similar promotion on a different vehicle type.

### Exemplary Use Case

The following exemplary use case describes just one example of a typical user flow pattern. It is intended solely for explanatory purposes and not in limitation. It should be noted that in some embodiments, the promotional aggregator system 110 may be the system that hosts the vehicle inventory website, with the data corresponding to these inventory entries being stored on the inventory database 112. In other embodiments, the inventory host system 130 may host the vehicle inventory website. In yet other embodiments, the vehicle inventory website may be directly hosted by the dealership system 140. These embodiments function substantively in the same manner, so in describing an example where the dealership system 140 hosts the inventory website, a person having ordinary skill in the art would understand that which of the dealership system 140, inventory host system 130, or the promotional aggregator system 110 hosts the inventory website may be freely interchangeable without substantively effecting the methods or systems disclosed herein. When the inventory is hosted by the promotional aggregator system 110, the system may receive promotions associated with a VIN or vehicle type (e.g., a vehicle type organized by make/model/year/trim) from the dealership system 140. When the inventory is not hosted by the promotional aggregator system 110 (e.g., when the inventory is hosted by either the dealership system 140 or the inventory host system 130), the system may first receive inventory information associated with at least one vehicle or one vehicle type before receiving at least one dealership promotion from the dealership system 140 and at least one service provider promotion from the service provider system 150.

First, a customer may wish to acquire (e.g., purchase or lease) a vehicle. To find the most advantageous deal, the customer may wish to access an inventory host website (e.g., hosted by the dealership system 140). The customer may already have some idea of what vehicle he/she wishes to purchase and may select either (i) specific vehicles (e.g., by a VIN) or (ii) a vehicle type(s). In response, the promotional aggregator system 110 may receive, from the dealership system 140 (or any of the previously mentioned systems that may be configured to act as the inventory website host), via a real-time API, a promotion identification request. The promotion identification request may include customer identification information (e.g., a full name, date of birth, social security number, etc.), customer preferences information (e.g., does the customer wish to prioritize a lower total price, a lower monthly payment, etc.), and information associated with at least one vehicle contained within an inventory listing presented on the dealership website. In some embodiments, the promotion identification request may further include customer financial information, which may enable the promotional aggregator system 110 to provide the customer with personalized financing information for each of the selected vehicles. For example, instead of seeing the generic asking price listed for a selected vehicle, the customer may instead see personalized financing information corresponding to loan terms that the customer has already been approved for.

The promotional aggregator system 110 may further receive from the dealership system 140 at least one dealership promotion associated with either the specific vehicle(s) or the vehicle type(s) associated with the specific vehicle(s). The promotional aggregator system 110 may also receive, from the service provider system 150 at least one service provider promotion associated with either the specific vehicle(s) or the vehicle type(s) associated with the specific vehicle(s). The promotional aggregator system 110 may determine the aggregated promotion recommendation including at least one service provider promotion and at least one dealership promotion for the customer selected vehicle type(s) or vehicle(s). In some embodiments, the promotional aggregator system 110 may further determine personalized financing information for the vehicles based on the provided customer financial information. It is contemplated that, in some embodiments (e.g., for some types of vehicle lease agreements), the dealership system 140 may provide both dealer-specific promotions and service provider-specific promotions associated with a particular vehicle for lease to the promotional aggregator system 110. In such embodiments, the dealership system 140 may first obtain the service provider-specific promotions from one or more service provider systems 150.

The promotional aggregator system 110 may provide to the dealership system 140 via the real-time API, the determined aggregated promotion recommendation for presentation on the inventory website. This allows the customer to seamlessly choose the vehicle or vehicle type of interest that fits the customer criteria and has a preselected combination of promotions applied to the vehicle corresponding to the customer preferences. In some embodiments, the promotional aggregator system may further provide to the dealership system 140 via the real-time API the determined personalized financing information for the vehicles based on the customer provided customer financial information. This information allows a more direct cross comparison of selected vehicles, because the customer can directly compare the financial burden corresponding to any vehicle (e.g. allowing for a direct cross-comparison of vehicle type X with vehicle type Y on a variety of elements, such as monthly payment, required down payment, applicable interest rates, and so on).

In some embodiments, determining the aggregated promotion recommendation including at least one service provider promotion and at least one dealership promotion for the selected vehicle(s) may further comprise tracking historical promotion data of both the service provider promotions and the dealership promotions for the vehicle type associated with the selected vehicle (i.e., the model corresponding to a vehicle). The historical promotion data may include promotion data, inventory data, and a customer acceptance rate of a particular promotion. Based on these determinations, the system may provide to the inventory website a suggested time window to purchase a vehicle, or even a suggested geographic location to purchase a vehicle. For example, the system may determine that for the vehicle that the customer has specified, and for the customer preferences indicated, the optimal time to buy the vehicle may be in December, because the in the past the dealership has provided a lowered monthly payment promotion on last year's model in anticipation of the next model year arriving at the dealership. Alternatively or additionally, the system may suggest one or more preferred geographic locations following a similar approach. For example, the system may determine that for the specific vehicle type (e.g., a Ford F-150) selected by the customer, the lowest total price after application of all applicable promotions may be found in the Midwest rather than the Southeast where the customer may reside.

In some embodiments, the system may use the tracked historical promotion data of both the service provider promotions and the dealership promotions for the vehicle type associated with the selected vehicle to provide to the dealership system and/or the service provider system suggested new promotion(s) based on the tracked historical data. For example, the system may log the customer acceptance rate for each promotion as it is applied to a particular vehicle or vehicle type. The system may suggest a new promotion for a dealership based on a similar promotion bringing in a high customer acceptance rate in a different geographical location. Accordingly, the promotional aggregator system 110 may also suggest a new promotion for a service provider based on a similar promotion bringing a higher customer acceptance rate in a different geographical location. Similarly, the system may analyze customer acceptance rates for a particular promotion as applied to a selected vehicle based on different time windows. The system may, for example, determine that a new promotion should be offered during a suggested time window for a dealership or service provider system based on customer acceptance rates being higher during that time window as determined by analyzing the historical promotion data.

As used in this application, the terms “component,” “module,” “system” and the like are intended to include a computer-related entity, such as but not limited to hardware, firmware, a combination of hardware and software, software, or software in execution. For example, a component may be, but is not limited to being, a process running on a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Certain implementations of the disclosed technology are described above with reference to block and flow diagrams of systems and methods and/or computer program products according to example implementations of the disclosed technology. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, may be repeated, or may not necessarily need to be performed at all, according to some implementations of the disclosed technology.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks. As an example, implementations of the disclosed technology may provide for a computer program product, including a computer-usable medium having a computer-readable program code or program instructions embodied therein, said computer-readable program code adapted to be executed to implement one or more functions specified in the flow diagram block or blocks. Likewise, the computer program instructions may be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

Throughout the specification and the claims, the following terms take at least the meanings explicitly associated herein, unless the context clearly dictates otherwise. The term “connected” means that one function, feature, structure, or characteristic is directly joined to or in communication with another function, feature, structure, or characteristic. The term “coupled” means that one function, feature, structure, or characteristic is directly or indirectly joined to or in communication with another function, feature, structure, or characteristic. The term “or” is intended to mean an inclusive “or.” Further, the terms “a,” “an,” and “the” are intended to mean one or more unless specified otherwise or clear from the context to be directed to a singular form.

In this description, numerous specific details have been set forth. It is to be understood, however, that implementations of the disclosed technology may be practiced without these specific details. In other instances, well-known methods, structures and techniques have not been shown in detail in order not to obscure an understanding of this description. References to “one embodiment,” “an embodiment,” “some embodiments,” “example embodiment,” “various embodiments,” “one implementation,” “an implementation,” “example implementation,” “various implementations,” “some implementations,” etc., indicate that the implementation(s) of the disclosed technology so described may include a particular feature, structure, or characteristic, but not every implementation necessarily includes the particular feature, structure, or characteristic. Further, repeated use of the phrase “in one implementation” does not necessarily refer to the same implementation, although it may.

As used herein, unless otherwise specified the use of the ordinal adjectives “first,” “second,” “third,” etc., to describe a common object, merely indicate that different instances of like objects are being referred to, and are not intended to imply that the objects so described must be in a given sequence, either temporally, spatially, in ranking, or in any other manner.

While certain implementations of the disclosed technology have been described in connection with what is presently considered to be the most practical and various implementations, it is to be understood that the disclosed technology is not to be limited to the disclosed implementations, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain implementations of the disclosed technology, including the best mode, and also to enable any person skilled in the art to practice certain implementations of the disclosed technology, including making and using any devices or systems and performing any incorporated methods. The patentable scope of certain implementations of the disclosed technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A vehicle promotion aggregator system for providing personalized aggregated promotion recommendations for incorporation into a dealership website via an API, the system comprising:
one or more processors; and
a memory in communication with the one or more processors and storing instructions that, when executed by the one or more processors, are configured to cause the system to:
receive, from a dealership system via a real-time API configured to provide promotion recommendations, a promotion identification request for a customer comprising customer identification information, customer preferences information, and information associated with at least one vehicle contained within an inventory listing presented on a dealership website associated with the dealership system;
receive, from a first promotion provider system, one or more service provider promotions associated with the at least one vehicle contained in the inventory listing;
receive, from a second promotion provider system different from the first promotion provider system, one or more dealership promotions associated with the at least one vehicle contained in the inventory listing;
aggregate the one or more service provider promotions provided by the first promotion provider system and the one or more dealership promotions provided by the second promotion provider system to form one or more aggregated promotions, each of the one or more aggregated promotions having at least one of the one or more service provider promotions paired with at least one of the one or more dealership promotions;
determine, based on the customer preferences information, an aggregated promotion recommendation comprising a first aggregated promotion of the one or more aggregated promotions, the first aggregated promotion comprising a first service provider promotion of the one or more service provider promotions and a first dealership promotion of the one or more dealership promotions for the at least one vehicle; and
provide, to the dealership system via the real-time API, the determined aggregated promotion recommendation for presentation on the dealership website, wherein the determined aggregated promotion recommendation comprises prospective financial discount information corresponding to each of the at least one vehicle.

2. The system of claim 1, wherein the determined aggregated promotion recommendation further comprises, for each of the at least one vehicle, a total price of the at least one vehicle, a risk value indicative of potential future costs not covered by the first service provider promotion and the first dealership promotion, and a total savings value that the first service provider promotion and the first dealership promotion provide.

3. The system of claim 1, wherein the instructions, when executed by the one or more processors, are further configured to cause the system to receive, from the dealership system via the real-time API, a customer-input indication of acceptance of the determined aggregated promotion recommendation and, responsive to the acceptance, provide, to the first promotion provider system and the second promotion provider system via the real-time API, a promotion lock message indicating the acceptance of the determined aggregated promotion recommendation.

4. The system of claim 1, wherein each of the at least one vehicle has an associated vehicle type, and the instructions, when executed by the one or more processors, are further configured to cause the system to track historical promotion data of at least the first service provider promotion and the first dealership promotion for the associated vehicle type of the at least one vehicle and determine a suggested time window to purchase each of the at least one vehicle based on the historical promotion data, wherein the suggested time window indicates that a current discount available in a current time period and expiring before the suggested time window is less valuable than a future discount available during the suggested time window based on the customer preferences information.

5. The system of claim 1, wherein each of the at least one vehicle has an associated vehicle type, and the instructions, when executed by the one or more processors, are further configured to cause the system to track historical promotion data of at least the first service provider promotion and the first dealership promotion for the associated vehicle type of the at least one vehicle and determine a suggested geographic location to purchase each of the at least one vehicle based on the historical promotion data.

6. The system of claim 1, wherein each of the at least one vehicle has an associated vehicle type, and the instructions, when executed by the one or more processors, are further configured to cause the system to:
track historical promotion data for the associated vehicle type of the at least one vehicle, the historical promotion data comprising the first dealership promotion, inventory data for the associated vehicle type for each of the at least one vehicle, and a customer acceptance rate of the first dealership promotion; and
provide, to the second promotion provider system, a suggested new promotion based on the tracked historical promotion data.

7. The system of claim 1, wherein each of the at least one vehicle has an associated vehicle type, and the instructions, when executed by the one or more processors, are further configured to cause the system to:
track historical promotion data for the associated vehicle type of the at least one vehicle, the historical promotion data comprising the first service provider promotion, inventory data for the associated vehicle type for each of the at least one vehicle, and a customer acceptance rate of the first service provider promotion; and
provide, to the first promotion provider system, a suggested new promotion based on the tracked historical promotion data.

8. The system of claim 1, wherein the promotion identification request further comprises customer financial information and the instructions, when executed by the one or more processors, are further configured to cause the system to determine personalized financing information for the at least one vehicle based on the customer financial information and the determined aggregated promotion recommendation and provide, to the dealership system via the real-time API, the personalized financing information for presentation on the dealership website.

9. A promotion aggregator system for providing personalized aggregated promotion recommendations for incorporation into an inventory website via an API, the system comprising:
one or more processors; and
a memory in communication with the one or more processors and storing instructions that, when executed by the one or more processors, are configured to cause the system to:
receive, from an inventory host system via a real-time API configured to provide promotion recommendations, a promotion identification request for a customer comprising customer identification information, customer preferences information, and information associated with at least one item contained within an inventory listing presented on an inventory website associated with the inventory host system;
receive, from a service provider system, one or more service provider promotions associated with the at least one item contained in the inventory listing;
receive, from a dealership system different from the service provider system, one or more dealership promotions associated with the at least one item contained in the inventory listing;
aggregate the one or more service provider promotions and the one or more dealership promotions based on the customer preferences information to form one or more aggregated promotions each having at least one of the one or more service provider promotions and at least one of the one or more dealership promotions;
determine, based on the customer preferences information, an aggregated promotion recommendation comprising a first aggregated promotion of the one or more aggregated promotions, the first aggregated promotion having a first service provider promotion of the one or more service provider promotions and a first dealership promotion of the one or more dealership promotions for the at least one item; and
provide, to the inventory host system via the real-time API, the determined aggregated promotion recommendation for presentation on the inventory website, wherein the determined aggregated promotion recommendation comprises prospective financial discount information corresponding to each of the at least one item.

10. The system of claim 9, wherein the determined aggregated promotion recommendation further comprises, for each of the at least one vehicle, a total price of the at least one vehicle, a risk value indicative of potential future costs not covered by the first service provider promotion and the first dealership promotion, and a total savings value that the first service provider promotion and the first dealership promotion provide.

11. The system of claim 9, wherein the instructions, when executed by the one or more processors, are further configured to cause the system to receive, from the inventory system via the real-time API, a customer-input indication of acceptance of the determined aggregated promotion recommendation and, responsive to the acceptance, provide, to the dealership system and the service provider system via the real-time API, a promotion lock message indicating the acceptance of the determined aggregated promotion recommendation.

12. The system of claim 9, wherein each of the at least one vehicle has an associated vehicle type, and determining an aggregated promotion recommendation further comprises tracking historical promotion data of at least the first service provider promotion and the first dealership promotion for the associated vehicle type of the at least one vehicle and determining a suggested time window to purchase each of the at least one vehicle based on the historical promotion data, wherein the suggested time window indicates that a current discount available in a current time period and expiring before the suggested time window is less valuable than a future discount available during the suggested time window based on the customer preferences information.

13. The system of claim 9, wherein each of the at least one vehicle has an associated vehicle type, and determining an aggregated promotion recommendation further comprises tracking historical promotion data of at least the first service provider promotion and the first dealership promotion for the associated vehicle type of the at least one vehicle and determining a suggested geographic location to purchase each of the at least one vehicle based on the historical promotion data.

14. The system of claim 9, wherein each of the at least one vehicle has an associated vehicle type, and determining an aggregated promotion recommendation further comprises:
tracking historical promotion data for the associated vehicle type of the at least one vehicle, the historical promotion data comprising the first dealership promotion, inventory data for the associated vehicle type for each of the at least one vehicle, and a customer acceptance rate of the first dealership promotion; and
providing, to the dealership system, a suggested new promotion based on the tracked historical promotion data.

15. The system of claim 9, wherein each of the at least one vehicle has an associated vehicle type, and determining an aggregated promotion recommendation further comprises:
tracking historical promotion data for the associated vehicle type of the at least one vehicle, the historical promotion data comprising the first service provider promotion, inventory data for the associated vehicle type for each of the at least one vehicle, and a customer acceptance rate of the first service provider promotion; and
providing, to the service provider system, a suggested new promotion based on the tracked historical promotion data.

16. The system of claim 9, wherein the promotion identification request further comprises customer financial information and the system further determines personalized financing information for the at least one vehicle based on the customer financial information and the determined aggregated promotion recommendation and provides, to the inventory host system via the real-time API, the personalized financing information for presentation on the inventory host website.

17. A method for providing personalized aggregated vehicle promotion recommendations, the method comprising:
receiving a promotion identification request for a customer comprising customer identification information, customer preferences information, and information associated with at least one item contained within an inventory listing presented on an inventory website;
receiving, from a service provider system, one or more service provider promotions associated with the at least one item contained in the inventory listing;
receiving, from a dealership system unaffiliated with the service provider system, one or more dealership promotions associated with the at least one item contained in the inventory listing;
aggregating, based on the customer preferences information, a compatible pair of a first service provider promotion of the one or more service provider promotions and a first dealership promotion of the one or more dealership promotions for the at least one item to form an aggregated promotion recommendation; and
providing the aggregated promotion recommendation for display on the inventory website, wherein the aggregated promotion recommendation comprises prospective financial discount information corresponding to each of the at least one item.

18. The method of claim 17, wherein the promotion identification request further comprises customer financial information, the method further comprising determining personalized financing information for the at least one vehicle based on the customer financial information and the aggregated promotion recommendation and providing the personalized financing information for display on the inventory website.

19. The method of claim 17, wherein each of the at least one vehicle has an associated vehicle type, and determining an aggregated promotion recommendation further comprises tracking historical promotion data of at least the first service provider promotion and the first dealership promotion for the associated vehicle type of the at least one vehicle and either (i) determining a suggested time window to purchase each of the at least one vehicle based on the historical promotion data, wherein the suggested time window indicates that a current discount available in a current time period and expiring before the suggested time window is less valuable than a future discount available during the suggested time window based on the customer preferences information, or (ii) determining a suggested geographic location to purchase each of the at least one vehicle based on the historical promotion data.

20. The method of claim 17, further comprising receiving a customer-input indication of acceptance of the aggregated promotion recommendation and, responsive to the acceptance, providing, to the dealership system and the service provider system, a promotion lock message indicating the acceptance of the aggregated promotion recommendation.
